(19) United States
(12) Patent Application Publication
(10) Pub. No.: US 2025/0175797 A1
(43) Pub. Date: May 29, 2025

(54) SERVICE MONITORING IN WIRELESS NETWORKS

(71) Applicant: Lenovo (Singapore) Pte. Limited, Singapore (SG)

(72) Inventors: Sheeba Backia Mary Baskaran, Friedrichsdorf (DE); Andreas Kunz, Ladenburg (DE)

(73) Assignee: Lenovo (Singapore) Pte. Limited, Singapore (SG)

(21) Appl. No.: 18/841,946

(22) PCT Filed: Feb. 16, 2023
(86) PCT No.: PCT/IB2023/051424

§ 371 Date: Aug. 27, 2024

Related U.S. Application Data
(60) Provisional application No. 63/314,924, filed on Feb. 28, 2022.

(51) Int. Cl. H04W 12/082; H04W 8/02; H04W 24/08

(52) U.S. Cl. CPC H04W 12/082; H04W 8/02; H04W 24/08

(57) ABSTRACT

Various aspects of the present disclosure relate to methods, apparatuses, and systems that support service monitoring in wireless networks. For instance, when a service request from a UE to a visited serving network is rejected, rejection reports can be generated and validated using secure techniques, such as via a blockchain and/or a permissioned distributed ledger (PDL). The information can then be maintained and communicated in a trusted and secure manner, such as to a home serving network and/or service providers that provide network services.

### RELATED APPLICATION

This application claims priority to U.S. Provisional Patent Application Ser. No. 63/314,924 filed 28 Feb. 2022 entitled “SERVICE MONITORING IN WIRELESS NETWORKS,” the disclosure of which is incorporated by reference herein in its entirety.

### TECHNICAL FIELD

The present disclosure relates to wireless communications, and more specifically to managing network services in wireless networks.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

Some wireless communications systems utilize network configurations that allow multiple network portions (e.g., virtualized and/or independent networks) to be created on top of a physical infrastructure. Each network portion can be characterized as a network slice that can be allocated based on the specific needs of a user, an application, use case, and so forth.

### SUMMARY

The present disclosure relates to methods, apparatuses, and systems that support service monitoring in wireless networks. For instance, when a service request from a UE to a visited serving network is rejected, rejection reports can be generated and validated using secure techniques, such as via a blockchain and/or a permissioned distributed ledger (PDL). The information can then be maintained and communicated in a trusted and secure manner, such as to a home serving network and/or service providers that provide network services. This provides secure and trusted ways for different functions associated with network services (e.g., a home serving network and/or 3^{rd} party service providers) to obtain information about network services provided by other networks, e.g., visited serving networks.

Some implementations of the method and apparatuses described herein may include wireless communication at a device (e.g., a UE), and the device receives a first message indicating a service rejection for a service associated with a network slice; generates, based at least in part on the received first message, a second message indicating the service rejection and a reference identifier associated with the service rejection; and outputs the generated second message.

In some implementations of the method and apparatuses described herein, the device (e.g., UE) transmits, to a visited network, a service request for the service associated with the network slice, where the receives the first message including receiving the first message from the visited network based at least in part on the transmitted service request to the visited network; where the first message further includes one or more of a rejection cause associated with the service rejection, identification information for the rejected service, identification information for the network slice, a freshness parameter, description information associated with the service rejection, or a timestamp associated with the service rejection; where the device generates the second message including generating one or both of a service rejection report for the service associated with the network slice or a digital signature associated with the service rejection report;

In some implementations of the method and apparatuses described herein, the device generates the service rejection report including using a function and one or more of sender information, a UE identifier, a network function identifier, a visited network identifier, subscribed slice identification information, subscribed service identification information, rejection cause information, or a timestamp; where the device generates the digital signature associated with the service rejection report using a security key; further including generating the reference identifier using a function and one or more of a freshness parameter, a UE identifier, a network function identifier, a serving network identifier, or a timestamp associated with the service rejection; where the device outputs the second message including outputting the second message using one or more of an application or an application programming interface (API) at a UE; where the device transmits the second message to one or more of a home public land mobile network (HPLMN) of a UE, a 3rd party service provider, a slice monitoring service, or a validator service.

Some implementations of the method and apparatuses described herein may include wireless communication at a device (e.g., a network node), and the device receives, from a UE, a service request for access to a service associated with a network slice; rejects, based on a condition, the service request; generates, based on the rejected service request, a first message indicating the service rejection and a reference identifier associated with the service rejection; and outputs the generated first message

In some implementations of the method and apparatuses described herein, the device (e.g., network node) generates the first message to include one or more of a UE identifier for the UE, a service type identifier for the service associated with the network slice, a rejection cause for the rejected service request, or a timestamp associated with the rejected service request; further including: transmitting the first message to the UE; generates a second message that includes at least some information from the first message; and outputs the generated second message to one or more of a HPLMN of the UE, a 3rd party service provider, a slice monitoring service, or a validator service; outputs the second message includes outputting the second message using one or more of an application or an API; receives a request for a report on the rejected service request, and generates and outputting the second message in response to the request.

Some implementations of the method and apparatuses described herein may include wireless communication at a device (e.g., a network node), and the device receives a first message generated by a UE, the first message including a first indication of a service rejection of a request by the UE for a service associated with a network slice and a first reference identifier associated with the service rejection; receives a second message generated by a network node, the second message including a second indication of a service rejection of a request by the UE for a service associated with a network slice and a second reference identifier associated with the service rejection; performs, based at least in part on the received first message and the received second message, a validation action to validate the first message and the second message; and outputs a validation report based on the validation action.

In some implementations of the method and apparatuses described herein, the device (e.g., network node) generates, based on the first message, a request for a report on the service rejection; transmits the request to the network node; and receives, from the network node, the second message as a reply to the request; further including one or both of where the device receives the first message from a slice monitoring service that is remote from the UE; or receives the second message from a slice monitoring service that is remote from the network node; wherein the device combines the first message and the second message to be recorded into a smart contract as part of the validation action; further including combining the first message and the second message into one or more of a blockchain or a PDL; where the network node is associated with a visited network, and the device transmits the validation report to one or both of a HPLMN of the UE or a 3^{rd} party service provider associated with the UE.

Some implementations of the method and apparatuses described herein may include wireless communication at a device (e.g., a network node), and the device receives, from a UE, a first message that includes a first indication of a service rejection of a service request by the UE for a service associated with a network slice and a first reference identifier associated with the service rejection; receives, from a network node, a second message that includes a second indication of a service rejection of a service request by the UE for a service associated with a network slice and a second reference identifier for the service rejection; and triggers, based at least in part on the first message and the second message, a validation action to validate the first message and the second message.

In some implementations of the method and apparatuses described herein, the device (e.g., network node) determines that the first reference identifier matches the second reference identifier, and triggers the validation action based on the first reference identifier matching the second reference identifier; transmits the first message and the second message to a validator service as part of the validation action; transmits an instruction to the validator service to validate the first message and the second message as part of the validation action.

### BRIEF DESCRIPTION OF THE DRAWINGS

Various aspects of the present disclosure for service monitoring in wireless networks are described with reference to the following Figures. The same numbers may be used throughout to reference like features and components shown in the Figures.

FIG. 1 illustrates an example of a wireless communications system that supports service monitoring in wireless networks in accordance with aspects of the present disclosure.

FIG. 2 illustrates an example of a system that supports service monitoring in wireless networks in accordance with aspects of the present disclosure.

FIG. 3 illustrates an example of a system that supports service monitoring in wireless networks in accordance with aspects of the present disclosure.

FIG. 4 illustrates an example of a system that supports service monitoring in wireless networks in accordance with aspects of the present disclosure.

FIG. 5 illustrates an example block diagram of components of a device that supports service monitoring in wireless networks in accordance with aspects of the present disclosure.

FIG. 6 illustrates an example block diagram of components of a device that supports service monitoring in wireless networks in accordance with aspects of the present disclosure.

FIG. 7 illustrates an example block diagram of components of a device that supports service monitoring in wireless networks in accordance with aspects of the present disclosure.

FIGS. 8-12 illustrate flowcharts of methods that support service monitoring in wireless networks in accordance with aspects of the present disclosure.

### DETAILED DESCRIPTION

The present disclosure relates to methods, apparatuses, and systems that support service monitoring in wireless networks. For instance, when a service request from a UE to a visited serving network is rejected, rejection reports can be generated and validated using secure techniques, such as via a blockchain and/or a PDL. The information can then be maintained and communicated in a trusted and secure manner, such as to a home serving network and/or service providers that provide network services. This provides secure and trusted ways for different functions associated with network services (e.g., a home serving network and/or 3^{rd} party service providers) to obtain information about network services provided by other networks, e.g., visited serving networks.

In some wireless communications systems, as part of registration of roaming UEs with a visited network, a home network can provide subscription data (e.g., along with slice subscription data) of a UE to the visited/serving network (e.g., a visited public land mobile network (VPLMN), a standalone non-public network (SNPN), etc.) to allow the VPLMN to serve the UE based on subscribed network slices, e.g., subscribed network slice selection assistance information (S-NSSAIs). Further, based on a service level agreement between a home network and a visited network, the visited network can be expected to serve the subscribes slices provided by the home network. However, in some scenarios, if a UE requests in a registration request a set of services (e.g., S-NSSAIs based on the subscribed S-NSSAI, such as the UE's subscribed slices with a home network and/or mobile network operator), a condition may cause the visited network to reject the request. For instance, the visited network such as due to lack of sufficient resources may deny or reject the subscribed slices requested by the UE for registration. Some wireless communications systems do not provide a means for a home network to know if a visited network is serving subscribed slices requested by the UE and/or if a requested subscribed slices are rejected by the visited network. The visited network in this case, for example, informs the UE about the rejected slices but does not send slice rejection information to the home network. Thus, in some wireless communications systems there is no method for a home network in a UE roaming scenario to monitor the UE's subscribed slice serving status from a visited network.

Accordingly, implementations of service monitoring in wireless networks are described, such as related to service monitoring in wireless networks. For instance, a UE associated with a home serving network (e.g., a HPLMN can register to receive services from a visited serving network, e.g., a VPLMN. Further, the services can be provided via network slices of the visited serving network. Accordingly, when the UE requests a service from the visited serving network (e.g., when the UE is in a roaming scenario and is connected to the visited serving network), the UE may receive a service rejection from the visited serving network. For instance, due to a condition at the visited serving network (e.g., insufficient service resources), the visited serving network rejects the request from the UE for provision of a service associated with a network slice and/or the service request fails at the visited serving network resulting in a service request failure.

Based on the rejected service request, implementations provide rejection reporting to enable information about the rejected service request to be shared and stored in a trusted manner. For instance, the UE that experiences the service rejection generates a first rejection report that includes different information about the service rejection, and communicates the first rejection report to a validator service. Further, the visited serving network that rejected the service request generates a second rejection report that includes different information about the service rejection, and communicates the second rejection report to the validator service. The validator service can perform a validation action based on the first rejection report and the second rejection report, such as utilizing validation and consensus by multiple validator nodes. In at least one implementation, information from the different rejection reports is written into instances of smart contracts, which are then utilized for validation and/or consensus. In at least some implementations, a smart contract represents a computer program and/or a transaction protocol generated to automatically execute, control and/or document relevant events and actions according to the terms of a contract and/or an agreement. Further, smart contracts can be implemented in conjunction with an oracle, which represents a means for smart contracts to access data from outside of a blockchain. An oracle, for instance, represents a type of smart contract that can take data from outside of a blockchain and put it into the blockchain, such as for other smart contracts to consume.

Accordingly, when the rejection reports are validated, information from the rejection reports can be stored such as by combining information from the first rejection report and the second rejection report into one or more of a blockchain or a PDL. The information can then be maintained and communicated in a trusted and secure manner, such as to a home serving network and/or service providers that provide network services. This provides secure and trusted ways for different functions associated with network services (e.g., a home serving network and/or 3^{rd} party service providers) to obtain information about network services provided by other networks, e.g., visited serving networks.

Aspects of the present disclosure are described in the context of a wireless communications system. Aspects of the present disclosure are further illustrated and described with reference to device diagrams and flowcharts that relate to service monitoring in wireless networks.

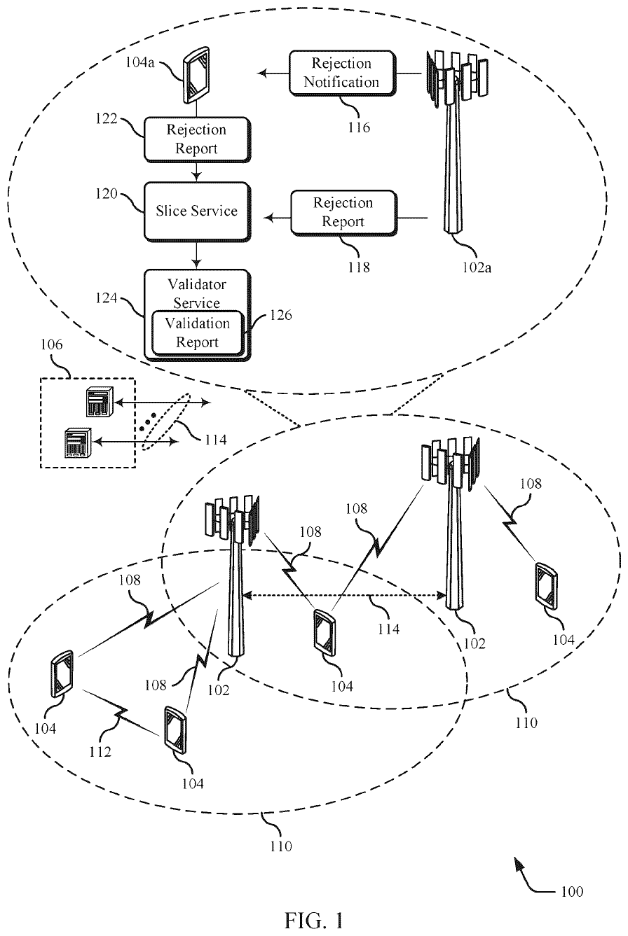

FIG. 1 illustrates an example of a wireless communications system 100 that supports service monitoring in wireless networks in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of the UEs 104 and base stations 102 are operable to implement various aspects of service monitoring in wireless networks, as described herein. For instance, based on a rejection of a service request by a UE 104a to a base station 102a (e.g., a base station associated with a visited network), the base station 102 communicates a rejection notification 116 to the UE 104a and a rejection report 118 to a slice service 120. The slice service 120 represents functionality for monitoring activity pertaining to network slices, such as services provided by network slices of an instance of a wireless network and/or instances of different wireless networks. Further, the UE 104a generates a rejection report 122 based at least in part on the rejection notification 116 and communicates the rejection report 122 to the slice service 120. The slice service 120 can then interact with a validator service 124 to communicate information about the service rejection to the validator service 124, such as at least some information from the rejection reports 118, 122. The validator service 124 can use this information to perform one or more validation actions and generate a validation report 126 based on validating the information from the rejection reports 118, 122. The validation report 126 can be implemented in various ways, such as smart contract, a blockchain, and/or a PDL that integrate(s) information from the rejection reports 118, 122. Further, the validation report 126 can be communicated to various entities, such as a home serving network of the UE 104a.

In some wireless communications systems, as part of registration of roaming UEs with a visited network, a home network can provide subscription data (e.g., along with slice subscription data) of a UE to the visited/serving network (e.g., VPLMN) to allow the VPLMN to serve the UE based on subscribed network slices, e.g., S-NSSAIs. Further, based on a service level agreement between a home network and a visited network, the visited network can be expected to serve the subscribes slices provided by the home network. However, in some scenarios, if a UE requests in a registration request a set of services (e.g., S-NSSAIs based on the subscribed S-NSSAI, such as the UE's subscribed slices with a home network and/or mobile network operator), a condition may cause the visited network to reject the request. For instance, the visited network such as due to lack of sufficient resources may deny or reject the subscribed slices requested by the UE for registration. In some wireless communications systems do not provide a means for a home network to know if a visited network is serving subscribed slices requested by the UE and/or if any requested subscribed slices are rejected by the visited network due to any reason. The visited network in this case, for example, informs the UE about the rejected slices but does not send slice rejection information to the home network. Thus, in some wireless communications systems there is no method for a home network in a UE roaming scenario to monitor the UE's subscribed slice serving status from a visited network.

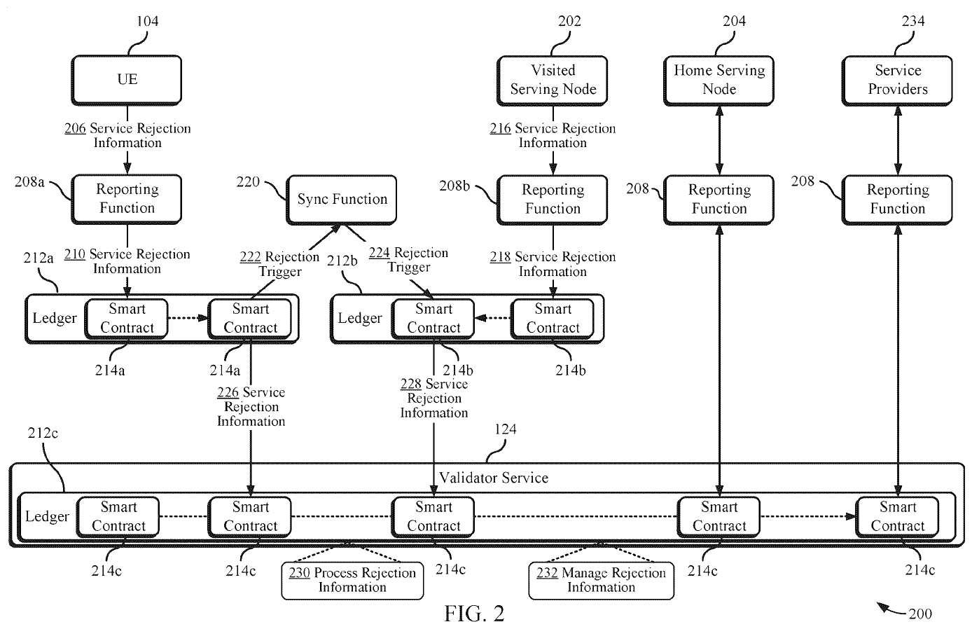

FIG. 2 illustrates an example of a system 200 that supports service monitoring in wireless networks in accordance with aspects of the present disclosure. The system 200 may use the wireless communications system 100 and/or be implemented with the wireless communications system. The system 200 describes an example implementation in which a UE and visited serving network can report to a home network (e.g., an actual service provider with whom the UE has subscribed for services) about a service rejection related to a UE's subscribed service in a secure manner. According to various implementations, the service rejection can be related to one or more of a slice service request rejection (e.g., requested S-NSSAIs related to subscribed slices rejection by a visited serving network) or a subscribed network serving rejection by the visited serving network during UE roaming.

In the system 200 a UE 104 is subscribed to a set of services with the home network operator (e.g., HPLMN) and the UE 104 is in roaming. While it is roaming the UE 104 tries to register with a visited serving node 202 of a visited serving network, e.g., a home serving network of the UE 104 has a service level agreement with a visited serving network to offer roaming service for subscribers of the home serving network based on subscribed services and/or slice information. The UE 104 sends one or more of a registration request, a protocol data unit (PDU) session establishment request, a PDU session modification request, or a service request to a network function of the visited serving network (e.g., AMF or SMF) via the visited serving node 202.

The network function of the visited serving network may perform authentication of the UE 104 and fetch subscription data along with slice subscription data and/or subscribed NSSAIs/S-NSSAIs of the UE 104 from unified data management (UDM). Further, the network function of the visited serving network, such as due to lack of resources or with intent, rejects one or more of the UEs requested services and/or slices (e.g., S-NSSAIs). The network function of the visited serving network then sends, via the visited serving node 202, rejected service information and cause information to the UE 104. To support trusted service rejection reporting, the network function of the visited serving network may send a reference identifier (ID) to trigger the UE 104 and the visited serving node 202 to report service rejection/rejection to a home serving node 204 of a home serving network of the UE 104 and/or a 3rd party service provider, such as based on an SLA-based conflict resolution and payment handling for roaming services.

Further to the system 200, the UE 104 generates first service rejection information which can be identified with a common reference number (e.g., a reference identifier sent by the visited serving node 202) along with a UE identifier for UE-side reporting. In at least one implementation the first service rejection information includes information such as:
a reference ID.
a UE ID, such as a subscription permanent identifier (SUPI), a privacy preserved identifier such as a generic public subscription identifier (GPSI), a digital identifier or other identifier provided by a home serving network for reporting purpose which is available to UE, visited serving network, home serving network, and/or 3rd party service provider.
a service type ID, such as related to a network slice/Subscribed NSSAIs/S-NSSAIs/or any service subscribed by the UE, e.g., aerial communications such for unmanned aerial systems (UAS), IoT, e.g., massive IoT, V2X, etc.
Rejection Cause, e.g., related to the service rejection or rejection by the visited serving network.
timestamp, e.g., a time instance when the UE's service request was rejected by the visited serving network.

At 206 the UE 104 can then send the first service rejection information using a reporting function 208a (e.g., an application and/or API) available to the UE 104 by initiating a transaction to a reporting address locally configured at the UE 104. The reporting function 208a, for instance, can send (e.g., may broadcast) data related to the first service rejection information to a set of validator nodes to perform validation and consensus. After a successful consensus (e.g., a maximum validator node confirmations), at 210 the first service rejection information can be added to a ledger 212a, e.g., a PDL. The first service rejection information, for instance, is recorded into a smart contract 214a.

In the system 200 the visited serving node 202 generates second service rejection information which can be identified with a common reference number (e.g., a reference identifier assigned by the visited serving network) along with the visited serving network identifier for visited serving network side reporting. The second service rejection information can include a reference ID and a source/sender information set such as visited serving network identification information. In at least one implementation the first service rejection information includes information such as:
a reference ID.
a UE ID, such as SUPI, a privacy preserved identifier such as GPSI, a digital identifier or other identifier provided by a home serving network for reporting purpose which is available to UE, visited serving network, home serving network, and/or 3rd party service provider.
a service type ID, such as related to a network slice/Subscribed NSSAIs/S-NSSAIs/or any service subscribed by the UE, e.g., aerial communications such for unmanned aerial systems (UAS), IoT, e.g., massive IoT, V2X, etc.
Rejection Cause, e.g., related to the service rejection or rejection by the visited serving network.
timestamp, e.g., a time instance when the UE's service request was rejected by the visited serving network.

According to implementations, a rejection cause can be related to a network slice service rejection and/or other network service rejection provided by a visited serving network to a UE. A rejection cause, for instance, notifies a UE and/or other party about the reason for rejecting a UE requested service. Examples of rejection causes include “S-NSSAI not available in the current PLMN or SNPN,” “S-NSSAI not available in the current registration area,” “S-NSSAI not available due to maximum number of UEs reached,” etc.

At 216 the visited serving node 202 can then send the second service rejection information using a reporting function 208b (e.g., an application and/or API) available to the visited serving node 202 such as by initiating a transaction to a reporting address locally configured at the visited serving node 202 and/or in an application, such as an application function. The visited serving node 202 can send the second service rejection transaction in various ways, such as directly, via an application/API, via a network exposing function available in the visited serving network, etc. Further, the reporting function 208b can send (e.g., may broadcast) the data related to the second service rejection information to the set of validator nodes to perform validation and consensus. After a successful consensus (e.g., a maximum validator node confirmations), at 218 the second service rejection information is added to a ledger 212b. The second service rejection information, for instance, is recorded into a smart contract 214b.

Various implementations provide service rejection information triggers using an inter-ledger sync function 220, such as a synch application. For instance, the smart contact 214a is configured and defined to handle service rejection information by a stakeholder of the consortium such as the visited serving network, a home serving network, and/or other service provider. At 222, the smart contract 214a on receiving a block in the ledger 212a related to the service rejection information may trigger the ledger 212b (e.g., directly or via another designated smart contract) for service rejection reporting via the sync function 220. The smart contract 214a, for instance, sends a service rejection information trigger which can include a reference ID, UE ID, serving node information, timestamp, etc.

Alternatively, if the ledger 212b does not receives a trigger for the reference ID from the ledger 212a via the sync function 220, the smart contract 214b on receiving a block in the ledger 212b related to the service rejection information may trigger (either directly or via another designated smart contract) service rejection reporting of the UE 104 via the sync function 220. The smart contract 214b, for instance, sends a service rejection information trigger which can include reference ID, UE ID, serving node information, timestamp, etc.

At 224, the sync function 220, such as in response to a trigger from the smart contract 214a and/or the smart contract 214b, sends a service rejection information trigger to the ledger 212b (e.g., which records the visited serving network service status data) to initiate an inter-ledger data sync operation. The inter-ledger sync operation, for instance, causes the ledger 212b to fetch the service rejection information locally stored in its block and to provide it to a ledger 212c using a smart contract responsible for inter-ledger interoperability. The ledger 212c, for instance, is maintained by the validator service 124 and is utilized to perform validation of service rejection information, such as via various validation and consensus procedures. The service rejection information, for instance, can be identified and fetched based on service rejection trigger information (such as reference ID, UE ID, serving node information, etc.) received from the sync function 220. The reference ID along with other information such as UE ID, timestamp and serving node information can be used by a smart contract to identify the right service rejection information block from the network side related to the UE-generated service rejection information.

At 226 the smart contract 214a in the ledger 212a may send the service rejection information as a transaction to another destination address configured in the smart contract 214a which may broadcast the transaction to a set of validator nodes responsible for a common consensus across involved stakeholders that implement the validator service 124 and the ledger 212c, such as via the home serving network, visited serving network, 3rd party service providers, and so forth. The service rejection information, for instance, is added as a block to a common consensus ledger, e.g., ledger 212c.

In an alternative or additional implementation, the smart contract 214a after a successful service rejection information trigger may send the service rejection information as a transaction and stores in another ledger which is built over a common consensus across the involved stakeholders such as home serving network, visited serving network, 3rd party service providers, and so forth, e.g., ledger 212c. In at least one implementation, the service rejection information transaction from the UE 104 and the service rejection information transaction from the visited serving node 202 can be handled, received, and/or processed via a single smart contract 214 at the ledger 212c or by different smart contracts at the ledger 212c.

Further to the system 200 at 228 the smart contract 214b in the ledger 212b may send the service rejection information as a transaction to another destination address configured in the smart contract 214b which may broadcast the transaction to a set of validator nodes responsible for a common consensus across involved stakeholders that implement the validator service 124 and the ledger 212c, such as via the home serving network, visited serving network, 3rd party service providers, and so forth. The service rejection information, for instance, is added as a block to a common consensus ledger, e.g., ledger 212c. In an alternative or additional implementation, the smart contract 214b after a successful service rejection information trigger may send the service rejection information as a transaction and stores in another ledger which is built over a common consensus across the involved stakeholders such as home serving network, visited serving network, 3rd party service providers, and so forth, e.g., ledger 212c.

At 230 and according to one or more implementations for both the UE 104 and visited serving node 202: The smart contract(s) in the ledger 212c, on receiving the service rejection information transaction related to the UE 104 from the ledger 212a and the service rejection information transaction related to the visited serving node 202 from the ledger 212b, the ledger 212c can store and/or add this information as a combined single block (e.g., combined service rejection information by inter-smart contract communication), or store and/or add this information in different blocks. For instance, service rejection information transactions from the UE 104 and the visited serving node 202 are stored and/or added separately, such as in the order that they are received. The smart contract 214c, for instance, stores a reference number and a block reference/identification of the ledger 212c where the combined service rejection information and/or service rejection information for the UE 104 and the visited serving node 202, respectively, are stored in an online and/or offline ledger or storage, such as to enable resolution of conflicts and/or settlements related to financial and service level agreements.

At 232 the smart contract 214c in the ledger 212c is configured to manage the service rejection information of the UE 104 and the visited serving node 202. Further, if the smart contract 214c is configured to report a trigger to the home serving node 204 and/or service providers 234 (e.g., 3^{rd} party service providers), then the smart contract 214c may trigger notifications related to service rejection information to the home serving node 204 and/or service providers 234 via the reporting function 208 to support service rejection information notification. For instance, if service rejection information reaches a particular threshold (e.g., based on a number of service rejections), notifications related to the service rejections can be triggered.

According to various implementations, the different communications and transactions discussed in the system 200 may happen in parallel and/or in any suitable sequence. Further, actions 222, 224 can either be initiated from ledger 212a or ledger 212b, such as based on which ledger initially gets the service rejection information related to a reference ID. The actions 226, 228 can be executed after a successful trigger in actions 222, 224. When the ledger 212c related to common consensus receives the service rejection information from the ledgers 212a, 212b, the ledger 212c may combine the service rejection information transaction from the UE 104 and the visited serving node 202 as one block or multiple blocks (e.g., two respective blocks) with reference to each other recorded in a storage and/or smart contract. The service rejection information stored in the ledger 212c can be queried and/or used by a home service provider and/or 3rd party service provider to resolve service level agreements related to the roaming service rejection for subscribers, e.g., the subscribed UE 104.

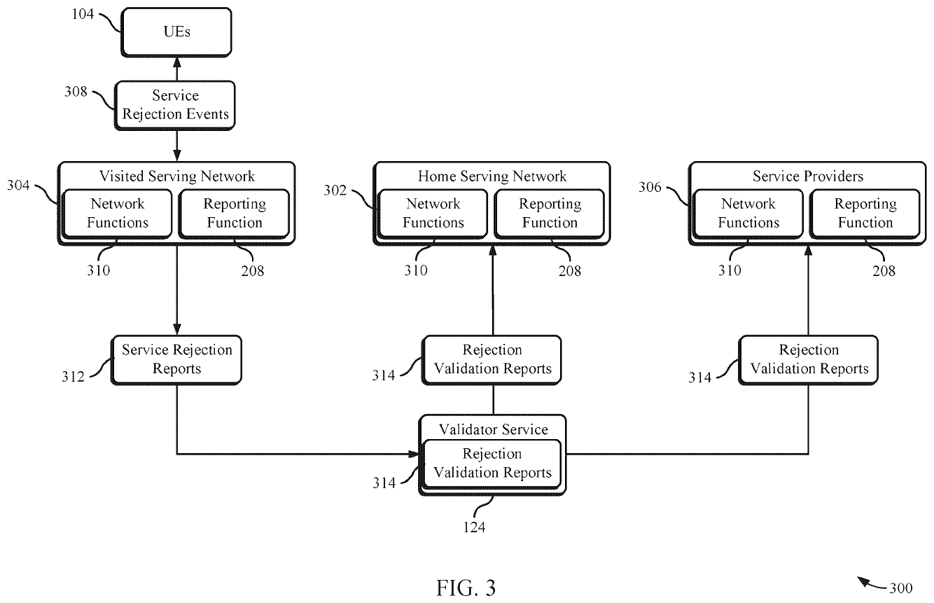

FIG. 3 illustrates an example of a system 300 that supports service monitoring in wireless networks in accordance with aspects of the present disclosure. The system 300 may use the wireless communications system 100 and/or be implemented with the wireless communications system. The system 300 describes example implementations in which the validation service 124 can be implemented by a consortium of a home serving network 302 along with one or more visited serving networks 304 and service providers 306 (e.g., 3rd party service providers). According to various implementations, the validation service 124 can be implemented via an application function and/or interworking function involved in different blockchain transactions and/or PDL transactions and can handle service impact and management related to slice service rejections.

According to various implementations, service rejection events 308 occur where the visited serving network 304 may deny service of a network slices to UEs 104 (e.g., due to insufficient network slice resources and/or or due to limited resources available at the visiting serving network 304), even if the UEs 104 have subscriptions to the requested network slices in the home serving network 302. In some scenarios, the home serving network 302 may not have direct visibility of slice denial of certain subscribed slices for the UEs 104, whereas the home serving network 302 may have SLAs established with the visited serving networks 304 to serve the specific slices. When the service rejection events 308 occur, network functions 310 (e.g., AMF) in the visited serving network 304 can record the rejection data in a blockchain and a smart contract can trigger related slice service rejection/non availability recording to the home serving network 302, such as to ensure slice service alignment and availability in UE 104 roaming scenarios.

For instance, in response to the service rejection events 308, the visited serving network 304 and/or the UEs 104 communicate service rejection reports 312 that include service rejection information to the validator service 124. Examples of different service rejection information are detailed throughout this disclosure. In at least one implementation the service rejection reports 312 can be communicated to the validator service 124 via the reporting function 208 and/or directly by the network functions 310. The validator service 124 processes the service rejection reports 312 and generates rejection validation reports 314, such as by performing validation and consensus on the service rejection reports 312. The validator service 124 can communicate the rejection validation reports 314 to various entities, such as the home serving network 302, the service providers 306, and so forth.

According to various implementations, utilizing blockchain as part of service rejection reporting enables trusted and verifiable tracking of service rejection occurrences. For instance, if the visited serving network 304 provides a slice rejection report to UDM over a service-based interface (SBI) in a mobile operator network, then there is a chance that the visited serving network 304 can deny such slice service rejections in the future. If the home serving network 302 determines to take a slice service compliance action or impose any charge reduction and/or penalty, then the home serving network 302 can utilize a credible data track like blockchain or PDL which can show a service rejection record with transactions related to a slice rejection report to the visited serving network 304, the home serving network 302, and/or the service provider 306. According to various implementations, blockchain and/or PDL nodes run by the home serving network 302, the visited serving network 304, and/or the service providers 306 can implement at least a portion of the validator service 124. Further, the UEs 104, nodes and/or network functions of the visited serving network 304, nodes and/or network functions of the home serving network 302, and/or nodes and/or network functions of the service providers 306 can send and view service rejection transactions using an API and/or application (e.g., the reporting function 208) residing at its particular location or via a dedicated application function or interworking function supported in the home serving network 302. The service rejection reports and related transactions can be sent, for instance, to the validator service 124 for validation, consensus, and storage in a blockchain and/or PDL.

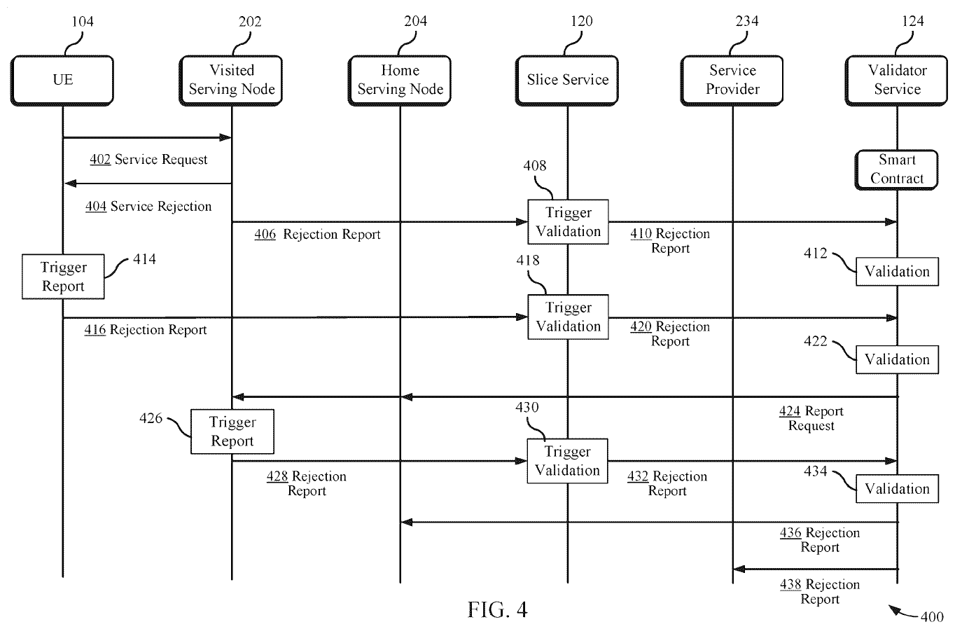

FIG. 4 illustrates an example of a system 400 that supports service monitoring in wireless networks in accordance with aspects of the present disclosure. The system 400 may use the wireless communications system 100 and/or be implemented with the wireless communications system. In the system 400, at 402 a UE 104 sends a service request to the visited serving node 202, such as part of a registration request, a PDU session establishment request, a PDU session modification request, and so forth. The service request, for instance, is related to a subscribed service and/or network slice (e.g., S-NSSAIs) to a NF associated with the visited serving node 202, e.g., an AMF, SMF, etc. In at least some implementations, during registration of the UE 104 the home serving node can do primary authentication of the UE 104 and NAS security can be established.

At 404 the visited serving node 202 (e.g., a network function of the visited serving network) rejects the service request from the UE 104 and sends a service rejection that includes rejected slice information (e.g., rejected NSSAIs/S-NSSAIs), a nonce/random number/counter (e.g., the freshness parameter such as a nonce/random number/counter can be used for slice service rejection report tracking reference ID generation), and information describing a cause and/or reason for the slice rejection along with a network identifier for a visited serving network associated with the visited serving node 202. Alternatively or additionally, the UE 104 may already know the serving network identifier. In implementations, a freshness parameter represents a nonce number, random number, and/or counter assigned for a service rejection which can be used to generate a reference identifier to identify a service rejection report provided by a UE and/or a visited serving network. A UE provided service rejection report can be identified by the reference identifier and UE identification information. The serving network provided service rejection report can identified by the reference identifier and serving network identification information.

At 406 the visited serving node 202 (e.g., via a NF) generates a service rejection report and communicates the service rejection report to the slice service 120. The service rejection report can include various information such as a report reference ID, UE ID for the UE 104, subscribed slice identification (for S-NSSAIs), service rejection code, service rejection reason, sequence number (SN) ID, NF ID, time stamp, and so forth. The visited serving node 202 (e.g., via a NF) sends the rejection report to the slice service 120 based on one or more of a configured reporting IP address, fully qualified domain name (FQDN), application server, etc., either directly or via any application function (e.g., the reporting function 208) associated with the visited serving node 202. In at least one implementation, the rejection report transaction can be signed by the visited serving node 202 using a private key by generating the hash of the transaction and encrypting it with the private key. The public key and related SN ID of the network for the slice service 120 can be available with a service provider associated with the home serving node 204 and/or a verifier authorized by the home serving node 204 to enable slice rejection report validation. In at least one implementation a report reference ID can be generated as: Hash (UE ID, Visited Serving Network ID, NF ID, random number/nonce/counter).

At 408 the slice service 120 triggers validation of the rejection report and at 410 the slice service 120 can communicate (e.g., broadcast) the transaction which contains the slice rejection report along with a digital signature to the validator service 124, e.g., a peer network which consists of validator nodes that runs a consensus algorithm. Accordingly, at 412 the validator service 124 attempts validation of the rejection report if a consensus is reached based on the rejection report, the rejection report along with digital signature is transacted to the configured blockchain and/or PDL, where a slice availability monitoring smart contract can keep track of the slice rejection report to manage related notifications.

At 414 the UE triggers rejection report generation (e.g., based on the service rejection) and at 416 the UE 104 generates a slice rejection report and communicates the slice rejection report to the slice service 120. The slice rejection report can include various information such as a report reference ID, UE ID, subscribed slice identification (e.g., S-NSSAIs), rejection code, rejection reason, SN ID, NF ID, timestamp, and so forth. In at least one implementation the UE 104 sends the rejection report transaction to an API/Application available in the UE (e.g., a reporting function 208) or additionally or alternatively, the transaction can be sent to a configured reporting IP address, FQDN, and/or application server either directly over a user plane connection or over NAS, which can route the rejection report to an application function residing at the visited serving node 202 and/or the home serving node 204 over the control plane. The slice rejection report transaction can be signed by the UE 104 using its private key by generating the hash of the transaction and encrypting it with the private key. The public key and related UE ID of the UE 104 for the slice service 120 can be available with a service provider of the home serving node 204 and/or a verifier authorized by the home serving node 204 to enable slice rejection report validation. In at least one implementation a report reference ID can be generated as: Hash (UE ID, serving network ID, NF ID, random number/nonce/counter).

At 418 the slice service 120 triggers validation of the rejection report and at 420 the slice service 120 can communicate (e.g., broadcast) the transaction which contains the slice rejection report along with a digital signature to the validator service 124, e.g., a peer network which consists of validator nodes that runs a consensus algorithm. Accordingly, at 422 the validator service 124 attempts validation of the rejection report from the UE 104 and if a consensus is reached based on the rejection report, the rejection report along with digital signature is transacted to the configured blockchain and/or PDL, where a slice availability monitoring smart contract can keep track of the slice rejection report to manage related notifications.

According to one or more alternative or additional implementations, at 424 the validator service 124 (e.g., via a smart contract) sends a report request (e.g., a subscribed slice rejection validation trigger) with various information (e.g., a report reference ID, UE ID, SN ID, NF ID and a timestamp) to the visited serving node 202. The validator service 124, for instance, communicates the report request to the visited serving node 202 via the home serving node 204 which is designated for handling slice management, and/or via an application function or network exposure function designated to support requesting slice rejection reports from a visited serving network for subscribers of a home serving network and/or for users which have subscriptions with the service provider 234. In at least one implementation the validator service 124 sends the report request at 424 when the visited serving node 202 does not initially send a rejection report, e.g., at 406.

Accordingly, the visited serving node 202 receives the report request, at 426 triggers rejection report generation based on the report request, and at 428 generates a service rejection report and communicates the service rejection report to the slice service 120. Various attributes of the service rejection report are discussed above at 406. At 430 the slice service 120 triggers validation of the rejection report and at 432 the slice service 120 can communicate (e.g., broadcast) the transaction which contains the slice rejection report along with a digital signature to the validator service 124. Accordingly, at 434 the validator service 124 attempts validation of the rejection report from the visited serving node 202 and if a consensus is reached based on the rejection report, the rejection report along with digital signature is transacted to the configured blockchain and/or PDL, where a slice availability monitoring smart contract can keep track of the slice rejection report to manage related notifications. For instance, the slice rejection reports from the UE 104 and the serving network node 202 can be stored as a block in the blockchain and/or PDL along with a timestamp indicating when the slice rejection reports were validated and added to the blockchain and/or ledger.

According to different implementations, based on validation of the rejection reports, at 436 the validator service 124 communicates a validation report to the home serving node 204 and/or at 438 the validator service 124 communicates a validation report to the service provider 234. For instance, the validator service 124 (e.g., via smart contracts in a slice rejection reporting management ledger (e.g., the ledger 212c) may trigger a notification to a home serving network, a slice service provider, and/or a 3rd party service provider about a slice service rejection report. For instance, in implementations where the validator service 124 utilizes smart contracts, the smart contracts can provide notifications when a number of slice service rejections exceed configured rejection thresholds. Further, if a home serving network, a slice service provider, and/or a 3rd party service provider is interested to know the slice serving status of a visited serving network for their subscribers, designated network nodes and/or network functions (e.g., an application server, UDM, policy control function (PCF), operations, administration and Management/Maintenance (OAM) and/or other NF) from the home serving network, a slice service provider, and/or a 3rd party service provider can anytime query the validator service 124 for the slice serving status, e.g., the slice service rejection status. Further, the slice serving status can be queried per UE, group of UEs, per network slice, per subset of network slices, per visited serving network, etc. Further, such queries can be submitted via an API and/or application and/or application function in a network. In at least some implementations, a home serving network, slice service provider, and/or 3rd party service provider can determine based on slice service status a slice service impact per UE subscription and can provide to a charging function accordingly, and/or can manage roaming service charges and resolve disputes accordingly.

In at least one implementation a PDL may store a slice rejection report, e.g., report reference ID, UE ID, subscribed slice identification information, rejection code, rejection reason, SN ID, NF ID, UE ID, subscribed slice identification rejection code, subscribed slice identification rejection reason, timestamp, and so forth. Further, a smart contract may trigger a preconfigured NF and/or management function when a slice SLA threshold has been violated based on slice rejection information received.

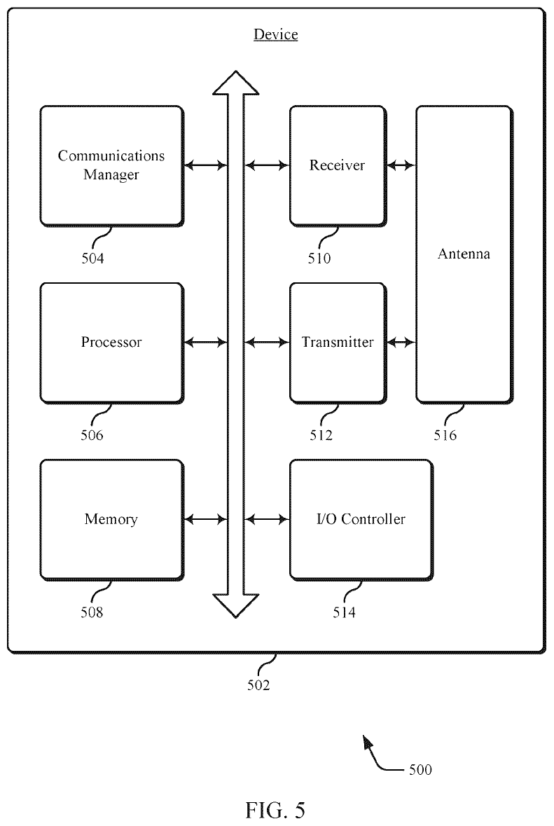

FIG. 5 illustrates an example of a block diagram 500 of a device 502 that supports service monitoring in wireless networks in accordance with aspects of the present disclosure. The device 502 may be an example of a UE 104 as described herein. The device 502 may support wireless communication and/or network signaling with one or more base stations 102, other UEs 104, network entities and devices, or any combination thereof. The device 502 may include components for bi-directional communications including components for transmitting and receiving communications, such as a communications manager 504, a processor 506, a memory 508, a receiver 510, a transmitter 512, and an I/O controller 514. These components may be in electronic communication or otherwise coupled (e.g., operatively, communicatively, functionally, electronically, electrically) via one or more interfaces (e.g., buses).

The communications manager 504, the receiver 510, the transmitter 512, or various combinations thereof or various components thereof may be examples of means for performing various aspects of the present disclosure as described herein. For example, the communications manager 504, the receiver 510, the transmitter 512, or various combinations or components thereof may support a method for performing one or more of the functions described herein.

In some implementations, the communications manager 504, the receiver 510, the transmitter 512, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 506 and the memory 508 coupled with the processor 506 may be configured to perform one or more of the functions described herein (e.g., by executing, by the processor 506, instructions stored in the memory 508).

Additionally or alternatively, in some implementations, the communications manager 504, the receiver 510, the transmitter 512, or various combinations or components thereof may be implemented in code (e.g., as communications management software or firmware) executed by the processor 506. If implemented in code executed by the processor 506, the functions of the communications manager 504, the receiver 510, the transmitter 512, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 504 may be configured to perform various operations (e.g., receiving, monitoring, transmitting) using or otherwise in cooperation with the receiver 510, the transmitter 512, or both. For example, the communications manager 504 may receive information from the receiver 510, send information to the transmitter 512, or be integrated in combination with the receiver 510, the transmitter 512, or both to receive information, transmit information, or perform various other operations as described herein. Although the communications manager 504 is illustrated as a separate component, in some implementations, one or more functions described with reference to the communications manager 504 may be supported by or performed by the processor 506, the memory 508, or any combination thereof. For example, the memory 508 may store code, which may include instructions executable by the processor 506 to cause the device 502 to perform various aspects of the present disclosure as described herein, or the processor 506 and the memory 508 may be otherwise configured to perform or support such operations.

For example, the communications manager 504 may support wireless communication and/or network signaling at a device (e.g., the device 502, a UE) in accordance with examples as disclosed herein. The communications manager 504 and/or other device components may be configured as or otherwise support an apparatus, such as a UE, including a transceiver; a processor coupled to the transceiver, the processor and the transceiver configured to cause the apparatus to: receive a first message indicating a service rejection for a service associated with a network slice; generate, based at least in part on the received first message, a second message indicating the service rejection and a reference identifier associated with the service rejection; and output the generated second message

Additionally, the apparatus (e.g., a UE) includes any one or combination of: where the processor and the transceiver are further configured to cause the UE to: transmit, to a visited network, a service request for the service associated with the network slice, where to receive the first message, the processor and the transceiver are configured to cause the UE to: receive the first message from the visited network based at least in part on the transmitted service request to the visited network; where the first message further includes one or more of a rejection cause associated with the service rejection, identification information for the rejected service, identification information for the network slice, a freshness parameter, description information associated with the service rejection, or a timestamp associated with the service rejection; the description information, for instance, represents additional information related to a service rejection notified by a serving network to the UE to enable the UE to obtain additional information about a rejected service. Examples of description information include a duration of a service rejection, whether and/or when service resumption may occur, possible alternative ways for a UE to obtain a requested service, etc.;

Additionally, the apparatus (e.g., a UE) includes any one or combination of: where, to generate the second message, the processor and the transceiver are configured to cause the UE to generate one or both of a service rejection report for the service associated with the network slice or a digital signature associated with the service rejection report; where the processor and the transceiver are configured to cause the UE to generate the service rejection report using a function and one or more of sender information, a UE identifier, a network function identifier, a visited network identifier, subscribed slice identification information, subscribed service identification information, rejection cause information, or a timestamp; where the processor and the transceiver are configured to cause the UE to generate the digital signature associated with the service rejection report using a security key; where the processor and the transceiver are configured to cause the UE to generate the reference identifier using a function and one or more of a freshness parameter, a UE identifier, a network function identifier, a serving network identifier, or a timestamp associated with the service rejection; where, to output the second message, the processor and the transceiver are configured to cause the UE to output the second message using one or more of an application or an API at the UE; where the processor and the transceiver are configured to cause the UE to transmit the second message to one or more of a HPLMN of the UE, a 3rd party service provider, a slice monitoring service, or a validator service; where, to output the second message, the processor and the transceiver are configured to cause the UE to output the generated second message for inclusion into a permissioned distributed ledger

The communications manager 504 and/or other device components may be configured as or otherwise support a means for wireless communication and/or network signaling at a UE, including receiving a first message indicating a service rejection for a service associated with a network slice; generating, based at least in part on the received first message, a second message indicating the service rejection and a reference identifier associated with the service rejection; and outputting the generated second message.

Additionally, wireless communication and/or network signaling at the UE includes any one or combination of: further including transmitting, to a visited network, a service request for the service associated with the network slice, where receiving the first message includes receiving the first message from the visited network based at least in part on the transmitted service request to the visited network; where the first message further includes one or more of a rejection cause associated with the service rejection, identification information for the rejected service, identification information for the network slice, a freshness parameter, description information associated with the service rejection, or a timestamp associated with the service rejection; where generating the second message includes generating one or both of a service rejection report for the service associated with the network slice or a digital signature associated with the service rejection report;

Additionally, wireless communication and/or network signaling at the UE includes any one or combination of: where generating the service rejection report includes using a function and one or more of sender information, a UE identifier, a network function identifier, a visited network identifier, subscribed slice identification information, subscribed service identification information, rejection cause information, or a timestamp; further including generating the digital signature associated with the service rejection report using a security key; further including generating the reference identifier using a function and one or more of a freshness parameter, a UE identifier, a network function identifier, a serving network identifier, or a timestamp associated with the service rejection; where outputting the second message includes outputting the second message using one or more of an application or an API at a UE; further including transmitting the second message to one or more of a HPLMN of a UE, a 3rd party service provider, a slice monitoring service, or a validator service; where outputting the generated second message comprises outputting the generated second message for inclusion into a permissioned distributed ledger.

The processor 506 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 506 may be configured to operate a memory array using a memory controller. In some other implementations, a memory controller may be integrated into the processor 506. The processor 506 may be configured to execute computer-readable instructions stored in a memory (e.g., the memory 508) to cause the device 502 to perform various functions of the present disclosure.

The memory 508 may include random access memory (RAM) and read-only memory (ROM). The memory 508 may store computer-readable, computer-executable code including instructions that, when executed by the processor 506 cause the device 502 to perform various functions described herein. The code may be stored in a non-transitory computer-readable medium such as system memory or another type of memory. In some implementations, the code may not be directly executable by the processor 506 but may cause a computer (e.g., when compiled and executed) to perform functions described herein. In some implementations, the memory 508 may include, among other things, a basic I/O system (BIOS) which may control basic hardware or software operation such as the interaction with peripheral components or devices.

The I/O controller 514 may manage input and output signals for the device 502. The I/O controller 514 may also manage peripherals not integrated into the device 502. In some implementations, the I/O controller 514 may represent a physical connection or port to an external peripheral. In some implementations, the I/O controller 514 may utilize an operating system such as iOS®, ANDROID®, MS-DOS®, MS-WINDOWS®, OS/2®, UNIX®, LINUX®, or another known operating system. In some implementations, the I/O controller 514 may be implemented as part of a processor, such as the processor 506. In some implementations, a user may interact with the device 502 via the I/O controller 514 or via hardware components controlled by the I/O controller 514.

In some implementations, the device 502 may include a single antenna 516. However, in some other implementations, the device 502 may have more than one antenna 516, which may be capable of concurrently transmitting or receiving multiple wireless transmissions. The receiver 510 and the transmitter 512 may communicate bi-directionally, via the one or more antennas 516, wired, or wireless links as described herein. For example, the receiver 510 and the transmitter 512 may represent a wireless transceiver and may communicate bi-directionally with another wireless transceiver. The transceiver may also include a modem to modulate the packets, to provide the modulated packets to one or more antennas 516 for transmission, and to demodulate packets received from the one or more antennas 516.

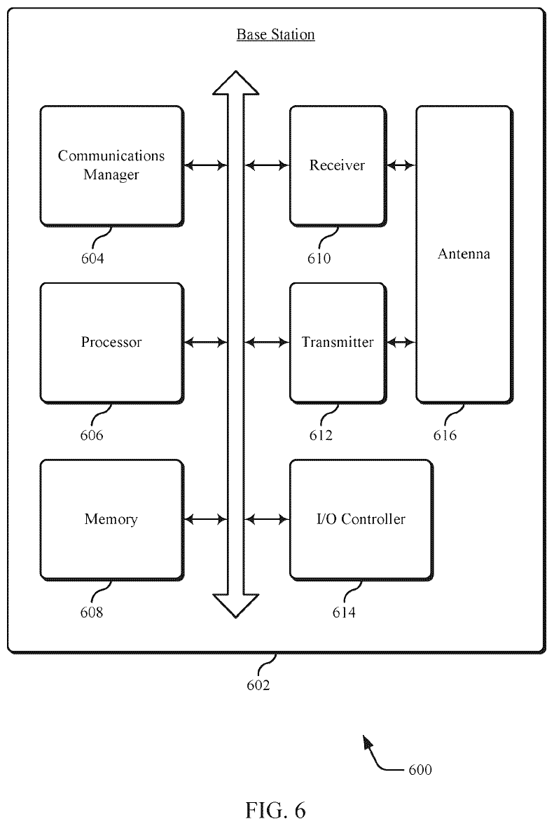

FIG. 6 illustrates an example of a block diagram 600 of a device 602 that supports service monitoring in wireless networks in accordance with aspects of the present disclosure. The device 602 may be an example of a base station 102, such as a gNB, and/or a network device as described herein. The device 602 may support wireless communication and/or network signaling with one or more base stations 102, other UEs 104, core network devices and functions (e.g., core network 106), or any combination thereof. The device 602 may include components for bi-directional communications including components for transmitting and receiving communications, such as a communications manager 604, a processor 606, a memory 608, a receiver 610, a transmitter 612, and an I/O controller 614. These components may be in electronic communication or otherwise coupled (e.g., operatively, communicatively, functionally, electronically, electrically) via one or more interfaces (e.g., buses).

The communications manager 604, the receiver 610, the transmitter 612, or various combinations thereof or various components thereof may be examples of means for performing various aspects of the present disclosure as described herein. For example, the communications manager 604, the receiver 610, the transmitter 612, or various combinations or components thereof may support a method for performing one or more of the functions described herein.

In some implementations, the communications manager 604, the receiver 610, the transmitter 612, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 606 and the memory 608 coupled with the processor 606 may be configured to perform one or more of the functions described herein (e.g., by executing, by the processor 606, instructions stored in the memory 608).

Additionally or alternatively, in some implementations, the communications manager 604, the receiver 610, the transmitter 612, or various combinations or components thereof may be implemented in code (e.g., as communications management software or firmware) executed by the processor 606. If implemented in code executed by the processor 606, the functions of the communications manager 604, the receiver 610, the transmitter 612, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 604 may be configured to perform various operations (e.g., receiving, monitoring, transmitting) using or otherwise in cooperation with the receiver 610, the transmitter 612, or both. For example, the communications manager 604 may receive information from the receiver 610, send information to the transmitter 612, or be integrated in combination with the receiver 610, the transmitter 612, or both to receive information, transmit information, or perform various other operations as described herein. Although the communications manager 604 is illustrated as a separate component, in some implementations, one or more functions described with reference to the communications manager 604 may be supported by or performed by the processor 606, the memory 608, or any combination thereof. For example, the memory 608 may store code, which may include instructions executable by the processor 606 to cause the device 602 to perform various aspects of the present disclosure as described herein, or the processor 606 and the memory 608 may be otherwise configured to perform or support such operations.

For example, the communications manager 604 may support wireless communication and/or network signaling at a device (e.g., the device 602) in accordance with examples as disclosed herein. The communications manager 604 and/or other device components may be configured as or otherwise support an apparatus, such as a base station and/or network device, including a transceiver; a processor coupled to the transceiver, the processor and the transceiver configured to cause the apparatus to: receive, from a UE, a service request for access to a service associated with a network slice; reject, based on a condition, the service request; generate, based on the rejected service request, a first message indicating the service rejection and a reference identifier associated with the service rejection; and output the generated first message.

Additionally, the apparatus (e.g., a base station and/or network device) includes any one or combination of: where the apparatus is associated with a VPLMN, and the processor and the transceiver are configured to cause the apparatus to generate the first message to include an identifier for the VPLMN; where the processor and the transceiver are configured to cause the apparatus to generate the first message to include one or more of a UE identifier for the UE, a service type identifier for the service associated with the network slice, a rejection cause for the rejected service request, or a timestamp associated with the rejected service request; where the apparatus is associated with a visited network, and the processor and the transceiver are configured to cause the apparatus to: transmit the first message to the UE; generate a second message that includes at least some information from the first message; and output the generated second message to one or more of a HPLMN of the UE, a 3rd party service provider, a slice monitoring service, or a validator service; where, to output the second message, the processor and the transceiver are configured to cause the apparatus to output the second message using one or more of an application or an API at the apparatus; where the processor and the transceiver are configured to cause the apparatus to receive a request for a report on the rejected service request, and to generate and output the second message in response to the request; where the processor and the transceiver are configured to cause the apparatus to generate and transmit the first message automatically and in response to the service request being rejected; where, to output the second message, the processor and the transceiver are configured to cause the apparatus to output the second message using one or more of an application or an application programming interface (API) that is external to the apparatus.

The communications manager 604 and/or other device components may be configured as or otherwise support a means for wireless communication and/or network signaling at a base station and/or network device, including receiving, from a UE, a service request for access to a service associated with a network slice; rejecting, based on a condition, the service request; generating, based on the rejected service request, a first message indicating the service rejection and a reference identifier associated with the service rejection; and outputting the generated first message.

Additionally, wireless communication at the base station and/or network device includes any one or combination of: further including generating the first message to include one or more of a UE identifier for the UE, a service type identifier for the service associated with the network slice, a rejection cause for the rejected service request, or a timestamp associated with the rejected service request; further including: transmitting the first message to the UE; generating a second message that includes at least some information from the first message; and outputting the generated second message to one or more of a HPLMN of the UE, a 3rd party service provider, a slice monitoring service, or a validator service; where outputting the second message includes outputting the second message using one or more of an application or an API; further including receiving a request for a report on the rejected service request, and generating and outputting the second message in response to the request; where the generated second message is output to be input to a PDL; where outputting the second message comprises outputting, by an apparatus, the second message using one or more of an application or an application programming interface (API) that is external to the apparatus.

The processor 606 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 606 may be configured to operate a memory array using a memory controller. In some other implementations, a memory controller may be integrated into the processor 606. The processor 606 may be configured to execute computer-readable instructions stored in a memory (e.g., the memory 608) to cause the device 602 to perform various functions of the present disclosure.

The memory 608 may include random access memory (RAM) and read-only memory (ROM). The memory 608 may store computer-readable, computer-executable code including instructions that, when executed by the processor 606 cause the device 602 to perform various functions described herein. The code may be stored in a non-transitory computer-readable medium such as system memory or another type of memory. In some implementations, the code may not be directly executable by the processor 606 but may cause a computer (e.g., when compiled and executed) to perform functions described herein. In some implementations, the memory 608 may include, among other things, a basic I/O system (BIOS) which may control basic hardware or software operation such as the interaction with peripheral components or devices.

The I/O controller 614 may manage input and output signals for the device 602. The I/O controller 614 may also manage peripherals not integrated into the device 602. In some implementations, the I/O controller 614 may represent a physical connection or port to an external peripheral. In some implementations, the I/O controller 614 may utilize an operating system such as iOS®, ANDROID®, MS-DOS®, MS-WINDOWS®, OS/2®, UNIX®, LINUX®, or another known operating system. In some implementations, the I/O controller 614 may be implemented as part of a processor, such as the processor 606. In some implementations, a user may interact with the device 602 via the I/O controller 614 or via hardware components controlled by the I/O controller 614.

In some implementations, the device 602 may include a single antenna 616. However, in some other implementations, the device 602 may have more than one antenna 616, which may be capable of concurrently transmitting or receiving multiple wireless transmissions. The receiver 610 and the transmitter 612 may communicate bi-directionally, via the one or more antennas 616, wired, or wireless links as described herein. For example, the receiver 610 and the transmitter 612 may represent a wireless transceiver and may communicate bi-directionally with another wireless transceiver. The transceiver may also include a modem to modulate the packets, to provide the modulated packets to one or more antennas 616 for transmission, and to demodulate packets received from the one or more antennas 616.

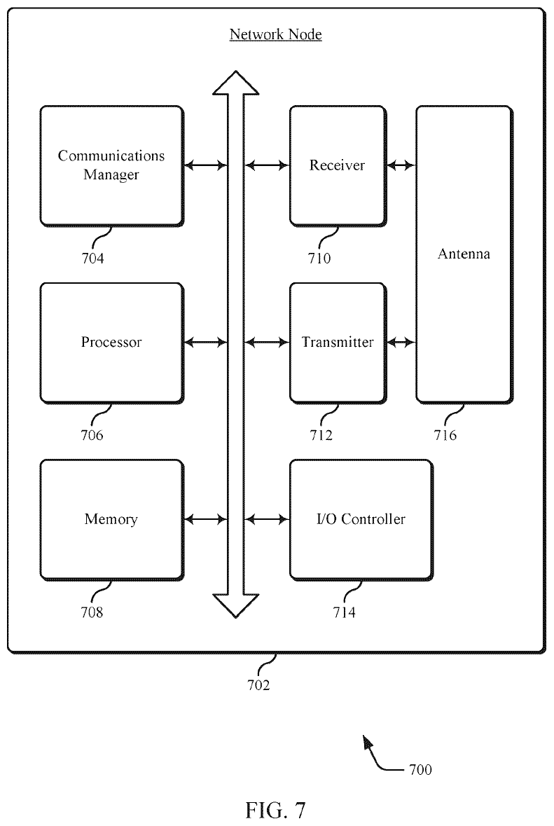

FIG. 7 illustrates an example of a block diagram 700 of a device 702 that supports service monitoring in wireless networks in accordance with aspects of the present disclosure. The device 702 may be an example of a network node such as device and/or set of devices associated with the validator service 124, the slice service 120, and so forth, as described herein. The device 702 may support wireless communication and/or network signaling with one or more base stations 102, other UEs 104, core network devices and functions (e.g., core network 106), or any combination thereof. The device 702 may include components for bi-directional communications including components for transmitting and receiving communications, such as a communications manager 704, a processor 706, a memory 708, a receiver 710, a transmitter 712, and an I/O controller 714. These components may be in electronic communication or otherwise coupled (e.g., operatively, communicatively, functionally, electronically, electrically) via one or more interfaces (e.g., buses).

The communications manager 704, the receiver 710, the transmitter 712, or various combinations thereof or various components thereof may be examples of means for performing various aspects of the present disclosure as described herein. For example, the communications manager 704, the receiver 710, the transmitter 712, or various combinations or components thereof may support a method for performing one or more of the functions described herein.

In some implementations, the communications manager 704, the receiver 710, the transmitter 712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 706 and the memory 708 coupled with the processor 706 may be configured to perform one or more of the functions described herein (e.g., by executing, by the processor 706, instructions stored in the memory 708).

Additionally or alternatively, in some implementations, the communications manager 704, the receiver 710, the transmitter 712, or various combinations or components thereof may be implemented in code (e.g., as communications management software or firmware) executed by the processor 706. If implemented in code executed by the processor 706, the functions of the communications manager 704, the receiver 710, the transmitter 712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 704 may be configured to perform various operations (e.g., receiving, monitoring, transmitting) using or otherwise in cooperation with the receiver 710, the transmitter 712, or both. For example, the communications manager 704 may receive information from the receiver 710, send information to the transmitter 712, or be integrated in combination with the receiver 710, the transmitter 712, or both to receive information, transmit information, or perform various other operations as described herein. Although the communications manager 704 is illustrated as a separate component, in some implementations, one or more functions described with reference to the communications manager 704 may be supported by or performed by the processor 706, the memory 708, or any combination thereof. For example, the memory 708 may store code, which may include instructions executable by the processor 706 to cause the device 702 to perform various aspects of the present disclosure as described herein, or the processor 706 and the memory 708 may be otherwise configured to perform or support such operations.

For example, the communications manager 704 may support wireless communication and/or network signaling at a device (e.g., the device 702, a network node) in accordance with examples as disclosed herein. The communications manager 704 and/or other device components may be configured as or otherwise support an apparatus, such as a network node, including a transceiver; a processor coupled to the transceiver, the processor and the transceiver configured to cause the apparatus to: receive a first message generated by a UE, the first message including a first indication of a service rejection of a request by the UE for a service associated with a network slice and a first reference identifier associated with the service rejection; receive a second message generated by a network node, the second message including a second indication of a service rejection of a request by the UE for a service associated with a network slice and a second reference identifier associated with the service rejection; perform, based at least in part on the received first message and the received second message, a validation action to validate the first message and the second message; and output a validation report based on the validation action.

Additionally, the apparatus (e.g., a network node) includes any one or combination of: where the processor and the transceiver are configured to cause the apparatus to: generate, based on the first message, a request for a report on the service rejection; transmit the request to the network node; and receive, from the network node, the second message as a reply to the request; where the processor and the transceiver are configured to cause the apparatus to perform one or both of to: receive the first message from a slice monitoring service that is remote from the UE; or receive the second message from a slice monitoring service that is remote from the network node; where the processor and the transceiver are configured to cause the apparatus to combine the first message and the second message to be recorded into a smart contract as part of the validation action; where the processor and the transceiver are configured to cause the apparatus to combine the first message and the second message into one or more of a blockchain or a PDL; where the network node is associated with a visited network, and where the processor and the transceiver are configured to cause the apparatus to transmit the validation report to one or both of a HPLMN of the UE or a 3rd party service provider associated with the UE.

The communications manager 704 and/or other device components may be configured as or otherwise support a means for wireless communication and/or network signaling at a network node, including receiving a first message generated by a UE, the first message including a first indication of a service rejection of a request by the UE for a service associated with a network slice and a first reference identifier associated with the service rejection; receiving a second message generated by a network node, the second message including a second indication of a service rejection of a request by the UE for a service associated with a network slice and a second reference identifier associated with the service rejection; performing, based at least in part on the received first message and the received second message, a validation action to validate the first message and the second message; and outputting a validation report based on the validation action.

Additionally, wireless communication at the network node includes any one or combination of: further including: generating, based on the first message, a request for a report on the service rejection; transmitting the request to the network node; and receiving, from the network node, the second message as a reply to the request; further including one or both of: receiving the first message from a slice monitoring service that is remote from the UE; or receiving the second message from a slice monitoring service that is remote from the network node; further including combining the first message and the second message to be recorded into a smart contract as part of the validation action; further including combining the first message and the second message into one or more of a blockchain or a PDL; where the network node is associated with a visited network, and the method further includes transmitting the validation report to one or both of a HPLMN of the UE or a 3rd party service provider associated with the UE.

As a further example, the communications manager 704 may support wireless communication and/or network signaling at a device (e.g., the device 702, network node) in accordance with examples as disclosed herein. The communications manager 704 and/or other device components may be configured as or otherwise support an apparatus, such as a network node, including a transceiver; a processor coupled to the transceiver, the processor and the transceiver configured to cause the apparatus to: receive, from a UE, a first message that includes a first indication of a service rejection of a service request by the UE for a service associated with a network slice and a first reference identifier associated with the service rejection; receive, from a network node, a second message that includes a second indication of a service rejection of a service request by the UE for a service associated with a network slice and a second reference identifier for the service rejection; and trigger, based at least in part on the first message and the second message, a validation action to validate the first message and the second message.

Additionally, the apparatus (e.g., a network node) includes any one or combination of: where the processor and the transceiver are configured to cause the apparatus to determine that the first reference identifier matches the second reference identifier, and to trigger the validation action based on the first reference identifier matching the second reference identifier; where the processor and the transceiver are configured to cause the apparatus to transmit the first message and the second message to a validator service as part of the validation action; where the processor and the transceiver are configured to cause the apparatus to transmit an instruction to the validator service to validate the first message and the second message as part of the validation action.

The communications manager 704 and/or other device components may be configured as or otherwise support a means for wireless communication and/or network signaling at a network node, including receiving, from a UE, a first message that includes a first indication of a service rejection of a service request by the UE for a service associated with a network slice and a first reference identifier associated with the service rejection; receiving, from a network node, a second message that includes a second indication of a service rejection of a service request by the UE for a service associated with a network slice and a second reference identifier for the service rejection; and triggering, based at least in part on the first message and the second message, a validation action to validate the first message and the second message.

Additionally, wireless communication at the network node includes any one or combination of: further including determining that the first reference identifier matches the second reference identifier, and triggering the validation action based on the first reference identifier matching the second reference identifier; further including transmitting the first message and the second message to a validator service as part of the validation action; further including transmitting an instruction to the validator service to validate the first message and the second message as part of the validation action.

The processor 706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 706 may be configured to operate a memory array using a memory controller. In some other implementations, a memory controller may be integrated into the processor 706. The processor 706 may be configured to execute computer-readable instructions stored in a memory (e.g., the memory 708) to cause the device 702 to perform various functions of the present disclosure.

The memory 708 may include random access memory (RAM) and read-only memory (ROM). The memory 708 may store computer-readable, computer-executable code including instructions that, when executed by the processor 706 cause the device 702 to perform various functions described herein. The code may be stored in a non-transitory computer-readable medium such as system memory or another type of memory. In some implementations, the code may not be directly executable by the processor 706 but may cause a computer (e.g., when compiled and executed) to perform functions described herein. In some implementations, the memory 708 may include, among other things, a basic I/O system (BIOS) which may control basic hardware or software operation such as the interaction with peripheral components or devices.

The I/O controller 714 may manage input and output signals for the device 702. The I/O controller 714 may also manage peripherals not integrated into the device 702. In some implementations, the I/O controller 714 may represent a physical connection or port to an external peripheral. In some implementations, the I/O controller 714 may utilize an operating system such as iOS®, ANDROID®, MS-DOS®, MS-WINDOWS®, OS/2®, UNIX®, LINUX®, or another known operating system. In some implementations, the I/O controller 714 may be implemented as part of a processor, such as the processor 706. In some implementations, a user may interact with the device 702 via the I/O controller 714 or via hardware components controlled by the I/O controller 714.

In some implementations, the device 702 may include a single antenna 716. However, in some other implementations, the device 702 may have more than one antenna 716, which may be capable of concurrently transmitting or receiving multiple wireless transmissions. The receiver 710 and the transmitter 712 may communicate bi-directionally, via the one or more antennas 716, wired, or wireless links as described herein. For example, the receiver 710 and the transmitter 712 may represent a wireless transceiver and may communicate bi-directionally with another wireless transceiver. The transceiver may also include a modem to modulate the packets, to provide the modulated packets to one or more antennas 716 for transmission, and to demodulate packets received from the one or more antennas 716.

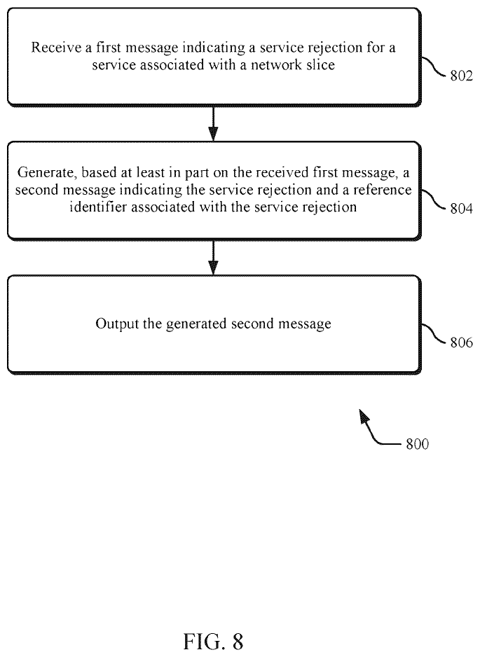

FIG. 8 illustrates a flowchart of a method 800 that supports service monitoring in wireless networks in accordance with aspects of the present disclosure. The operations of the method 800 may be implemented and performed by a device or its components, such as a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 802, the method may include receiving a first message indicating a service rejection for a service associated with a network slice. The operations of 802 may be performed in accordance with examples as described herein. In some implementations, aspects of the operations of 802 may be performed by a device as described with reference to FIG. 1.

At 804, the method may include generating, based at least in part on the received first message, a second message indicating the service rejection and a reference identifier associated with the service rejection. The operations of 804 may be performed in accordance with examples as described herein. In some implementations, aspects of the operations of 804 may be performed by a device as described with reference to FIG. 1.

At 806, the method may include outputting the generated second message. The operations of 806 may be performed in accordance with examples as described herein. In some implementations, aspects of the operations of 806 may be performed by a device as described with reference to FIG. 1.

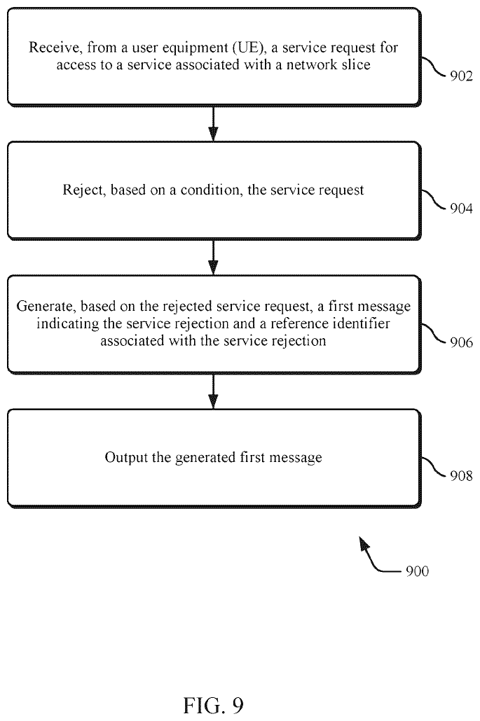

FIG. 9 illustrates a flowchart of a method 900 that supports service monitoring in wireless networks in accordance with aspects of the present disclosure. The operations of the method 900 may be implemented and performed by a device or its components, such as a base station 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 902, the method may include receiving, from a UE, a service request for access to a service associated with a network slice. The operations of 902 may be performed in accordance with examples as described herein. In some implementations, aspects of the operations of 902 may be performed by a device as described with reference to FIG. 1.

At 904, the method may include rejecting, based on a condition, the service request. The operations of 904 may be performed in accordance with examples as described herein. In some implementations, aspects of the operations of 904 may be performed by a device as described with reference to FIG. 1.

At 906, the method may include generating, based on the rejected service request, a first message indicating the service rejection and a reference identifier associated with the service rejection. The operations of 906 may be performed in accordance with examples as described herein. In some implementations, aspects of the operations of 906 may be performed by a device as described with reference to FIG. 1.

At 908, the method may include outputting the generated first message. The operations of 908 may be performed in accordance with examples as described herein. In some implementations, aspects of the operations of 908 may be performed by a device as described with reference to FIG. 1.

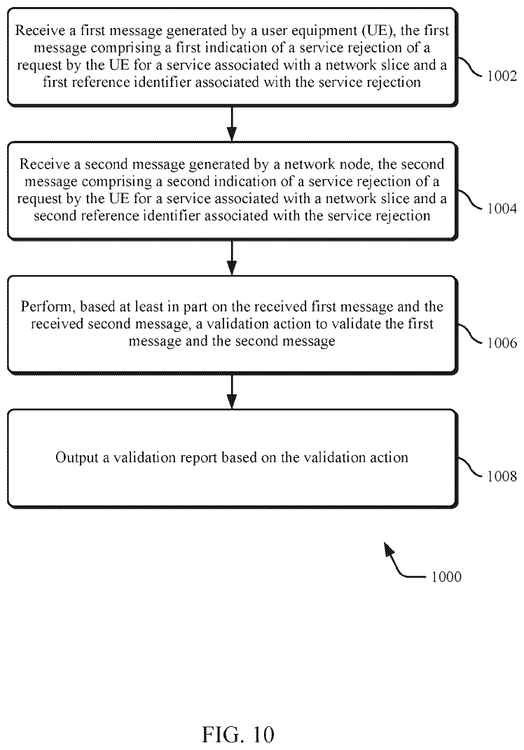

FIG. 10 illustrates a flowchart of a method 1000 that supports service monitoring in wireless networks in accordance with aspects of the present disclosure. The operations of the method 1000 may be implemented and performed by a device or its components, such as a network component that implements the validator service 124 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1002, the method may include receiving a first message generated by a UE, the first message comprising a first indication of a service rejection of a request by the UE for a service associated with a network slice and a first reference identifier associated with the service rejection. The operations of 1002 may be performed in accordance with examples as described herein. In some implementations, aspects of the operations of 1002 may be performed by a device as described with reference to FIG. 1.

At 1004, the method may include receiving a second message generated by a network node, the second message comprising a second indication of a service rejection of a request by the UE for a service associated with a network slice and a second reference identifier associated with the service rejection. The operations of 1004 may be performed in accordance with examples as described herein. In some implementations, aspects of the operations of 1004 may be performed by a device as described with reference to FIG. 1.

At 1006, the method may include performing, based at least in part on the received first message and the received second message, a validation action to validate the first message and the second message. The operations of 1006 may be performed in accordance with examples as described herein. In some implementations, aspects of the operations of 1006 may be performed by a device as described with reference to FIG. 1.

At 1008, the method may include outputting a validation report based on the validation action. The operations of 1008 may be performed in accordance with examples as described herein. In some implementations, aspects of the operations of 1008 may be performed by a device as described with reference to FIG. 1.

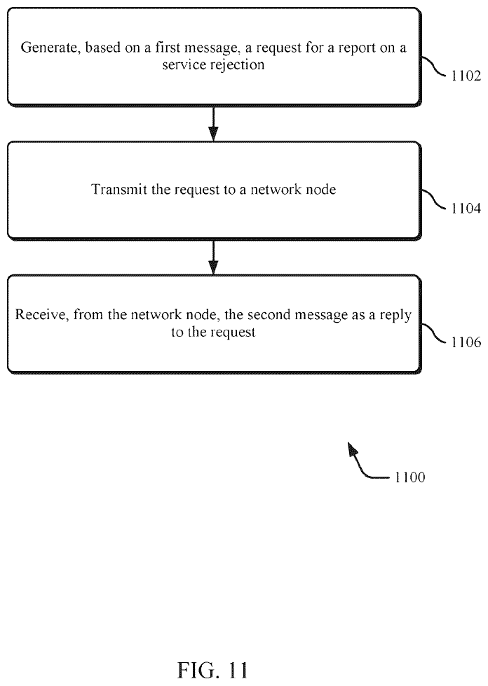

FIG. 11 illustrates a flowchart of a method 1100 that supports service monitoring in wireless networks in accordance with aspects of the present disclosure. The operations of the method 1100 may be implemented and performed by a device or its components, such as a network component that implements the validator service 124 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1102, the method may include generating, based on a first message, a request for a report on a service rejection. The operations of 1102 may be performed in accordance with examples as described herein. In some implementations, aspects of the operations of 1102 may be performed by a device as described with reference to FIG. 1.

At 1104, the method may include transmitting the request to a network node. The operations of 1104 may be performed in accordance with examples as described herein. In some implementations, aspects of the operations of 1104 may be performed by a device as described with reference to FIG. 1.

At 1106, the method may include receiving, from the network node, the second message as a reply to the request. The operations of 1106 may be performed in accordance with examples as described herein. In some implementations, aspects of the operations of 1106 may be performed by a device as described with reference to FIG. 1.

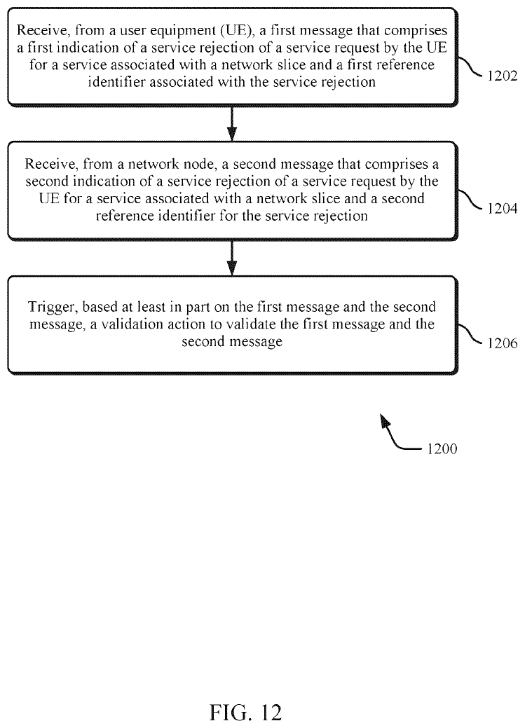

FIG. 12 illustrates a flowchart of a method 1200 that supports service monitoring in wireless networks in accordance with aspects of the present disclosure. The operations of the method 1200 may be implemented and performed by a device or its components, such as a network component that implements the slice service 120 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1202, the method may include receiving, from a UE, a first message that comprises a first indication of a service rejection of a service request by the UE for a service associated with a network slice and a first reference identifier associated with the service rejection. The operations of 1202 may be performed in accordance with examples as described herein. In some implementations, aspects of the operations of 1202 may be performed by a device as described with reference to FIG. 1.

At 1204, the method may include receiving, from a network node, a second message that comprises a second indication of a service rejection of a service request by the UE for a service associated with a network slice and a second reference identifier for the service rejection. The operations of 1204 may be performed in accordance with examples as described herein. In some implementations, aspects of the operations of 1204 may be performed by a device as described with reference to FIG. 1.

At 1206, the method may include triggering, based at least in part on the first message and the second message, a validation action to validate the first message and the second message. The operations of 1206 may be performed in accordance with examples as described herein. In some implementations, aspects of the operations of 1206 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (e.g., A and B and C). Similarly, a list of one or more of A, B, or C means A or B or C, or AB or AC or BC, or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) comprising:
at least one memory; and
at least one processor coupled with the at least one memory and configured to cause the UE to:
receive a first message indicating a service rejection for a service associated with a network slice;
generate, based at least in part on the received first message, a second message indicating the service rejection and a reference identifier associated with the service rejection; and
output the generated second message.

2. The UE of claim 1, wherein the at least one processor is further configured to cause the UE to:
transmit, to a visited network, a service request for the service associated with the network slice,
wherein to receive the first message, the at least one processor is configured to cause the UE to:
receive the first message from the visited network based at least in part on the transmitted service request to the visited network.

3. The UE of claim 1, wherein the first message further comprises one or more of a rejection cause associated with the service rejection, identification information for the rejected service, identification information for the network slice, a freshness parameter, description information associated with the service rejection, or a timestamp associated with the service rejection.

4. The UE of claim 1, wherein, to generate the second message, the at least one processor is configured to cause the UE to generate one or both of a service rejection report for the service associated with the network slice or a digital signature associated with the service rejection report.

5. The UE of claim 4, wherein the at least one processor is configured to cause the UE to:
generate the service rejection report using a function and one or more of sender information, a UE identifier, a network function identifier, a visited network identifier, subscribed slice identification information, subscribed service identification information, rejection cause information, or a timestamp; and
generate the digital signature associated with the service rejection report using a security key.

6. (canceled)

7. The UE of claim 1, wherein the at least one processor is configured to cause the UE to generate the reference identifier using a function and one or more of a freshness parameter, a UE identifier, a network function identifier, a serving network identifier, or a timestamp associated with the service rejection.

8. The UE of claim 1, wherein, to output the second message, the at least one processor is configured to cause the UE to output the second message using one or more of an application or an application programming interface (API) at the UE.

9. The UE of claim 1, wherein the at least one processor is configured to cause the UE to transmit the second message to one or more of a home public land mobile network (HPLMN) of the UE, a 3rd party service provider, a slice monitoring service, or a validator service.

10. An apparatus comprising:
at least one memory; and
at least one processor coupled with the at least one memory and configured to cause the apparatus to:
receive, from a user equipment (UE), a service request for access to a service associated with a network slice;
reject, based on a condition, the service request;
generate, based on the rejected service request, a first message indicating a service rejection and a reference identifier associated with the service rejection; and
output the generated first message.

11. The apparatus of claim 10, wherein the at least one processor is configured to cause the apparatus to generate the first message to include one or more of a UE identifier for the UE, a service type identifier for the service associated with the network slice, identification information about the rejected service or network slice, a freshness parameter, a rejection cause for the rejected service request, or a timestamp associated with the rejected service request.

12. The apparatus of claim 10, wherein the apparatus is associated with a visited network, and the at least one processor is configured to cause the apparatus to:
transmit the first message to the UE;
generate a second message that includes at least some information from the first message; and
output the generated second message to one or more of a home public land mobile network (HPLMN) of the UE, a 3^{rd} party service provider, a slice monitoring service, or a validator service.

13. The apparatus of claim 12, wherein, to output the second message, the at least one processor is are configured to cause the apparatus to output the second message using one or more of an application or an application programming interface (API) at the apparatus.

14. The apparatus of claim 12, wherein the at least one processor is configured to cause the apparatus to receive a request for a report on the rejected service request, and to generate and output the second message in response to the request.

15. An apparatus comprising:
at least one memory; and
at least one processor coupled with the at least one memory and configured to cause the apparatus to:
receive a first message generated by a user equipment (UE), the first message comprising a first indication of a service rejection of a request by the UE for a service associated with a network slice and a first reference identifier associated with the service rejection;
receive a second message generated by a network node, the second message comprising a second indication of a service rejection of a request by the UE for a service associated with a network slice and a second reference identifier associated with the service rejection;
perform, based at least in part on the received first message and the received second message, a validation action to validate the first message and the second message; and
output a validation report based on the validation action.

16. The apparatus of claim 15, wherein the at least one processor is configured to cause the apparatus to:
generate, based on the first message, a request for a report on the service rejection;
transmit the request to the network node; and
receive, from the network node, the second message as a reply to the request.

17. The apparatus of claim 15, wherein the at least one processor is configured to cause the apparatus to perform one or both of to:
receive the first message from a slice monitoring service that is remote from the UE; or
receive the second message from a slice monitoring service that is remote from the network node.

18. The apparatus of claim 15, wherein the at least one processor is configured to cause the apparatus to combine the first message and the second message to be recorded into a smart contract as part of the validation action.

19. The apparatus of claim 15, wherein the at least one processor is configured to cause the apparatus to combine the first message and the second message into one or more of a blockchain or a permissioned distributed ledger.

20. The apparatus of claim 15, wherein the network node is associated with a visited network, and wherein the at least one processor is configured to cause the apparatus to transmit the validation report to one or both of a home public land mobile network (HPLMN) of the UE or a 3^{rd} party service provider associated with the UE.

21. A processor for wireless communication, comprising:
at least one controller coupled with at least one memory and configured to cause the processor to:
receive a first message indicating a service rejection for a service associated with a network slice;
generate, based at least in part on the received first message, a second message indicating the service rejection and a reference identifier associated with the service rejection; and
output the generated second message.
